(19) United States
(12) Patent Application Publication
(10) Pub. No.: US 2018/0082266 A1
(43) Pub. Date: Mar. 22, 2018

(54) COMBINED AIRCRAFT MAINTENANCE ROUTING AND MAINTENANCE TASK SCHEDULING

(71) Applicant: BOMBARDIER INC., Dorval (CA)

(72) Inventor: Nima SAFAEI, Toronto (CA)

(21) Appl. No.: 15/562,123

(22) PCT Filed: Mar. 30, 2016
(86) PCT No.: PCT/IB2016/051807

§ 371 Date: Sep. 27, 2017

Related U.S. Application Data
(60) Provisional application No. 62/142,116, filed on Apr. 2, 2015.

(51) Int. Cl. G06Q 10/00; G06Q 10/10; G06Q 50/28

(52) U.S. Cl. CPC G06Q 10/20; G06Q 50/28; G06Q 10/1097

(57) ABSTRACT

A method and system for coordinating aircraft maintenance routing and scheduling for a fleet of aircraft over a given time period is described. The method comprises receiving an initial list of due maintenance tasks based on aircraft information of the fleet and a proposed fleet utilization distribution; generating a set of aircraft routes for the fleet, the routes comprising maintenance opportunities for the due maintenance tasks, the due maintenance tasks being considered as aggregated maintenance constraints for generation of the aircraft routes; scheduling the due maintenance tasks into the maintenance opportunities while respecting target due dates; and in case of infeasibility for maintenance task scheduling within the maintenance opportunities of the aircraft routes, regenerating the set of aircraft routes for the fleet using the aggregated maintenance constraints and additional constraints, and rescheduling the due maintenance tasks using the regenerated set of aircraft routes.

### CROSS-REFERENCE TO RELATED APPLICATIONS

This application claims priority under 35 U.S.C. 119(e) of U.S. Provisional Patent Application No. 62/142,116, filed on Apr. 2, 2015, and entitled “Combined Aircraft Maintenance Routing and Maintenance Task Scheduling”, the contents of which are hereby incorporated by reference.

### TECHNICAL FIELD

The present invention relates to the fields of aircraft maintenance routing and maintenance task scheduling.

### BACKGROUND OF THE ART

Aircraft maintenance routing (AMR) refers to determining the routes of individual aircrafts in a sequence of flight legs, so that each route will have sufficient maintenance opportunities to perform the maintenance tasks due. A maintenance opportunity occurs when an aircraft spends a sufficiently long period at a maintenance station for maintenance work to take place. Maintenance task scheduling (MTS) (also called maintenance work packaging) refers to which maintenance task should be done on which aircraft, and at which maintenance site.

Based on maintenance programs provided by aircraft manufacturers and mandated by various authorities, each type of aircraft has many detailed maintenance tasks that should be performed at specific intervals in terms of various usage parameters, such as Flight Hour/Cycle, Engine Hour/Cycle, Auxiliary Power Unit Hour, Time Calendar, etc. Maintenance stations do not necessarily support all types of maintenance procedures due to the lack of proper resources such as skilled labor, facility, space, and tools. In addition, each aircraft in a fleet may have a different age and utilization rate, which means the maintenance procedures crossing the scheduling horizon and accordingly the aircraft routings are most likely changed from one week to another.

In practice, due to the intensive mathematical complexity, AMR and MTS are dealt with separately using separate software packages, or even manually. Cyclic rotation and opportunistic maintenance on a day to day basis is used. There is a need to be able to address AMR and MTS in a more efficient manner.

### SUMMARY

There is described herein an integrated solution in order to coordinate AMR and MTS together, in an improved manner.

An interactive optimization decision model is used to coordinate AMR and MTS. An initial list of due maintenance tasks is projected based on an equal fleet utilization scenario (i.e. all aircrafts are used equally). The maintenance tasks are initially presented as maintenance constraints aggregated in terms of the required labor-hours to perform the tasks. A first iterative loop is used to generate a set of aircraft routes and to modify the aircraft routes until a best proposed solution is obtained.

A second iterative loop is then used to schedule the individual maintenance tasks in the maintenance opportunities provided by the routes as scheduled. When scheduling the maintenance tasks, additional maintenance constraints are considered, such as available staff, order of tasks, available equipment, etc. If the set of tasks cannot be properly scheduled in the maintenance opportunities, a backtracking strategy is used by repeating the first iterative loop with additional maintenance constraints, referred to as “cuts”. The cuts are used to permute the routes so that the newly generated solution is different from the previous solution(s).

In accordance with a first broad aspect, there is provided a method for coordinating aircraft maintenance routing and scheduling for a fleet of aircraft over a given time period. The method comprises receiving an initial list of due maintenance tasks based on aircraft information of the fleet and a proposed fleet utilization distribution; generating a set of aircraft routes for the fleet, the routes comprising maintenance opportunities for the due maintenance tasks, the due maintenance tasks being considered as aggregated maintenance constraints for generation of the aircraft routes; scheduling the due maintenance tasks into the maintenance opportunities while respecting target due dates; and in case of infeasibility for maintenance task scheduling within the maintenance opportunities of the aircraft routes, regenerating the set of aircraft routes for the fleet using the aggregated maintenance constraints and additional constraints, and rescheduling the due maintenance tasks using the regenerated set of aircraft routes.

In some embodiments, generating a set of aircraft routes comprises: generating a first set of aircraft routes based on the initial list of due maintenance tasks; determining if the initial list of due maintenance tasks needs revision in view of the first set of aircraft routes and if so generating an updated list of due maintenance tasks; and determining if the first set of aircraft routes need revision in view of the updated list of due maintenance tasks and if so generating an updated set of aircraft routes.

In some embodiments, scheduling the due maintenance tasks into the maintenance opportunities comprises: scheduling the due maintenance tasks based on an initial task timing tolerance; if the due maintenance tasks cannot be scheduled with the initial task timing tolerance, increasing the task timing tolerance and repeating the scheduling based on the increased task timing tolerance; and determining infeasibility for maintenance task scheduling when a maximum task timing tolerance is reached.

In some embodiments, the aggregated maintenance constraints correspond to labor-hours for a maintenance workload of each aircraft of the fleet over the given time period.

In some embodiments, scheduling the due maintenance tasks into the maintenance opportunities comprises determining if tasks that cannot be scheduled may be moved forward to previous periods as overflow.

In some embodiments, scheduling the due maintenance tasks into the maintenance opportunities comprises consolidating similar tasks into work packages and assigning the work packages to the maintenance opportunities.

In some embodiments, generating a set of aircraft routes for the fleet comprises imposing a condition of at least one of reducing an uneven fleet utilization and reducing non-revenue flights.

In some embodiments, generating a set of aircraft routes for the fleet comprises using a column generation algorithm, wherein each column corresponds to a route for an individual aircraft with a degree of maintenance feasibility.

In some embodiments, scheduling the due maintenance tasks into the maintenance opportunities comprises using a branch-and-bound algorithm.

In some embodiments, the proposed fleet utilization distribution is an equal fleet utilization distribution.

In some embodiments, the additional constraints are specific to a given maintenance task that cannot be scheduled in the maintenance opportunities as provided.

In accordance with another broad aspect, there is provided a system for coordinating aircraft maintenance routing and scheduling for a fleet of aircraft over a given time period. The system comprises a memory; a processor coupled to the memory; and at least one application stored in the memory and executable by the processor. The application is executable for receiving an initial list of due maintenance tasks based on aircraft information of the fleet and a proposed fleet utilization distribution; generating a set of aircraft routes for the fleet, the routes comprising maintenance opportunities for the due maintenance tasks, the due maintenance tasks being considered as aggregated maintenance constraints for generation of the aircraft routes; scheduling the due maintenance tasks into the maintenance opportunities while respecting target due dates; and in case of infeasibility for maintenance task scheduling within the maintenance opportunities of the aircraft routes, regenerating the set of aircraft routes for the fleet using the aggregated maintenance constraints and additional constraints, and rescheduling the due maintenance tasks using the regenerated set of aircraft routes.

In some embodiments, generating a set of aircraft routes comprises: generating a first set of aircraft routes based on the initial list of due maintenance tasks; determining if the initial list of due maintenance tasks needs revision in view of the first set of aircraft routes and if so generating an updated list of due maintenance tasks; and determining if the first set of aircraft routes need revision in view of the updated list of due maintenance tasks and if so generating an updated set of aircraft routes.

In some embodiments, scheduling the due maintenance tasks into the maintenance opportunities comprises: scheduling the due maintenance tasks based on an initial task timing tolerance; if the due maintenance tasks cannot be scheduled with the initial task timing tolerance, increasing the task timing tolerance and repeating the scheduling based on the increased task timing tolerance; and determining infeasibility for maintenance task scheduling when a maximum task timing tolerance is reached.

In some embodiments, the aggregated maintenance constraints correspond to labor-hours for a maintenance workload of each aircraft of the fleet over the given time period.

In some embodiments, scheduling the due maintenance tasks into the maintenance opportunities comprises determining if tasks that cannot be scheduled may be moved forward to previous periods as overflow.

In some embodiments, scheduling the due maintenance tasks into the maintenance opportunities comprises consolidating similar tasks into work packages and assigning the work packages to the maintenance opportunities.

In some embodiments, generating a set of aircraft routes for the fleet comprises imposing a condition of at least one of reducing an uneven fleet utilization and reducing non-revenue flights.

In some embodiments, generating a set of aircraft routes for the fleet comprises using a column generation algorithm, wherein each column corresponds to a route for an individual aircraft with a degree of maintenance feasibility.

In some embodiments, scheduling the due maintenance tasks into the maintenance opportunities comprises using a branch-and-bound algorithm.

In some embodiments, the proposed fleet utilization distribution is an equal fleet utilization distribution.

In some embodiments, the additional constraints are specific to a given maintenance task that cannot be scheduled in the maintenance opportunities as provided.

In accordance with yet another broad aspect, there is provided a computer readable medium having stored thereon program code executable by a processor for coordinating aircraft maintenance routing and scheduling for a fleet of aircraft over a given time period. The program code comprises instructions for receiving an initial list of due maintenance tasks based on aircraft information of the fleet and a proposed fleet utilization distribution; generating a set of aircraft routes for the fleet, the routes comprising maintenance opportunities for the due maintenance tasks, the due maintenance tasks being considered as aggregated maintenance constraints for generation of the aircraft routes; scheduling the due maintenance tasks into the maintenance opportunities while respecting target due dates; and in case of infeasibility for maintenance task scheduling within the maintenance opportunities of the aircraft routes, regenerating the set of aircraft routes for the fleet using the aggregated maintenance constraints and additional constraints, and rescheduling the due maintenance tasks using the regenerated set of aircraft routes.

In some embodiments, generating a set of aircraft routes comprises: generating a first set of aircraft routes based on the initial list of due maintenance tasks; determining if the initial list of due maintenance tasks needs revision in view of the first set of aircraft routes and if so generating an updated list of due maintenance tasks; and determining if the first set of aircraft routes need revision in view of the updated list of due maintenance tasks and if so generating an updated set of aircraft routes.

### BRIEF DESCRIPTION OF THE DRAWINGS

Further features and advantages of the present invention will become apparent from the following detailed description, taken in combination with the appended drawings, in which:

FIG. 1 is a flowchart of an exemplary method for coordinating AMR and MTS;

FIG. 2 is a flowchart of an exemplary method for generating a set of aircraft routes;

FIG. 3 is a flowchart of an exemplary method for scheduling maintenance tasks into maintenance opportunities;

FIG. 4 is a flowchart of an exemplary method for resolving AMR using column generation;

FIG. 5 is a flowchart of an exemplary method for coordinating AMR and MTS while considering overflow;

FIG. 6 is a block diagram of an exemplary system for coordinating AMR and MTS;

FIG. 7 is an exemplary embodiment of a maintenance routing and scheduling system 602;

FIG. 8 is an exemplary embodiment of an application running on the processor of the maintenance routing and scheduling system;

FIG. 9 is an exemplary embodiment of a maintenance routing module; and

FIG. 10 is an exemplary embodiment of a maintenance task scheduling module.

It will be noted that throughout the appended drawings, like features are identified by like reference numerals.

### DETAILED DESCRIPTION

Referring to the figures, there is described a method and system for coordinating aircraft maintenance routing (AMR) and maintenance task scheduling (MTS). AMR refers to determining routes of individual aircrafts in a sequence of flight legs over a given time period, so that each route will have sufficient opportunities to perform the maintenance tasks that are due. In other words, AMR ensures that the right aircraft is in the right place at the right time. A maintenance opportunity (MO) occurs when an aircraft spends a sufficiently long period of time at a maintenance station, whether or not maintenance is actually performed. MTS refers to determining which due maintenance task should be done on which aircraft, and at which maintenance site, MTS may also involve consolidating similar tasks as work packages and assigning them to available maintenance opportunities created by AMR, MTS involves taking into account the availability of various maintenance constraints, such as total man-hours required per aircraft (i.e. workload), availability of skilled labor for the different maintenance tasks, availability of space to perform the maintenance, availability of equipment for the maintenance, operating hours of the maintenance site, the order in which certain maintenance tasks are to be performed, and other factors that may have an impact on scheduling the individual due maintenance tasks in the available maintenance opportunities.

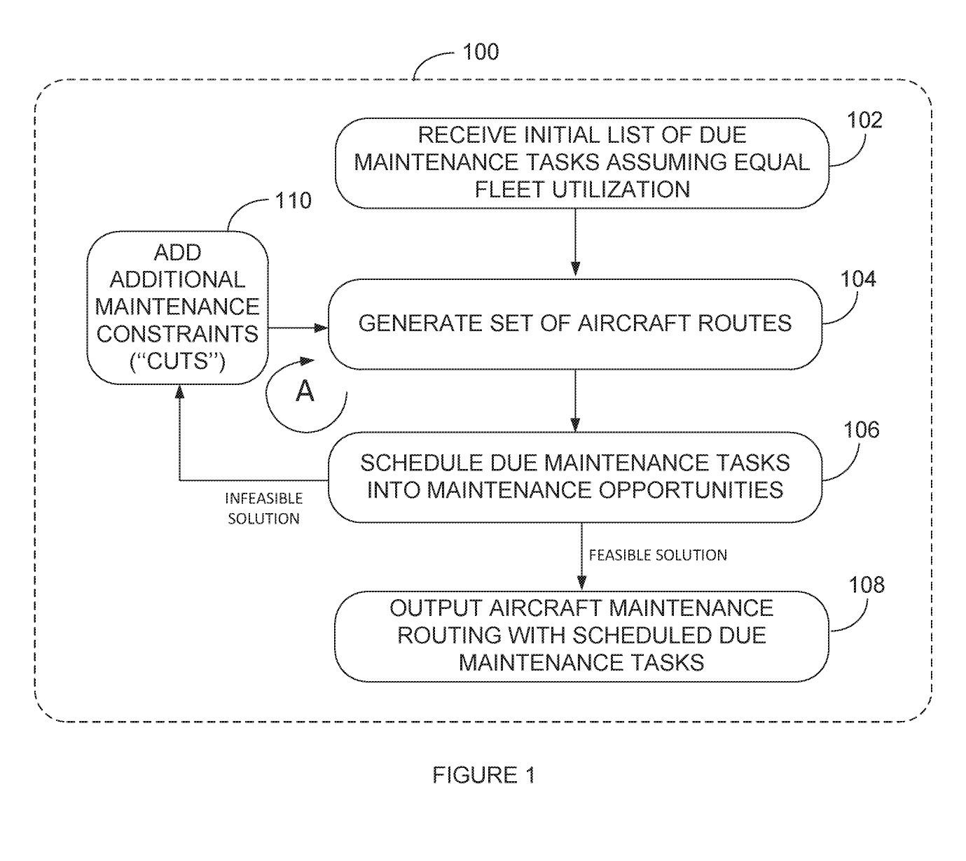

As such, AMR and MTS are performed sequentially with an interactive mechanism to coordinate the process. An exemplary embodiment of a method 100 for coordinating AMR and MTS is provided in FIG. 1. In a first step 102, an initial list of due maintenance tasks is received. In some embodiments, this step may comprise generating the list or obtaining it from a given source. The initial list may based on aircraft information, such as for example historical information of the aircraft fleet (e.g., age or cumulative days, cumulative usage parameters, current location of each aircraft, and the last check of each task). The initial list may have been generated (or be generated) based on a proposed fleet utilization distribution, such as an equalized fleet utilization (EFU) scenario or another desired distribution. Under EFU, all aircrafts are assumed to have the same usage rate, i.e., the same increment of flight hours (FH) or flight cycles (FC) per the given time period. There are many reasons for wanting to achieve EFU. For example, airlines may want to even out the wear and tear on aircraft over the long term by having equivalent maintenance histories. In addition, EFU avoids cyclical use patterns, leading to uneven wear, and has the potential to reduce the risk of routing disruptions due to unexpected breakdowns when different aircraft display different deterioration rates due to imbalanced usage. Finally, EFU can prevent a degenerating situation in which an iterative AMR process does not converge to a stable pattern and may be locked into a finite set of neighbor/similar solutions, Such a situation may occur due to the high sensitivity of the low-interval maintenance tasks related to aircraft usage rate.

Based on the initial list of due maintenance tasks, a set of aircraft routes are generated, as per step 104. The aircraft routes are provided with maintenance opportunities to satisfy the maintenance requirements of individual aircraft. The due maintenance tasks are initially presented as aggregated maintenance constraints. In some embodiments, the aggregated maintenance constraints are provided in terms of the required labor-hours to perform the due maintenance tasks. Alternatively, the aggregated maintenance constraints may represent another parameter for maintenance in an aggregated manner. Aircraft routes are generated so as to ensure that the aggregated maintenance constraints are met. In order to alleviate the complexity of finding a solution at this stage of the process, only the aggregated maintenance constraints, such as total labor-hours, are considered, not the actual breakdown required for each due maintenance task individually.

The aircraft routes are then used to schedule due maintenance tasks into maintenance opportunities while respecting target due dates, as per step 106. If a feasible solution is possible, an output is provided with the aircraft routes and the due maintenance tasks having been scheduled accordingly, as per step 108. In case of infeasibility for maintenance task scheduling, some additional constraints, so-called cuts, are added to make sure a new solution will be generated, as per step 110. In some embodiments, the additional constraints are generic and applicable to all aircrafts in the fleet for the given time period. For example, an additional constraint may comprise each aircraft having an overnight stay at a given airport at least once over the given time period. In another example, an additional constraint may comprise providing at least one block of 12 consecutive hours for each aircraft over the given time period. In some embodiments, the additional constraints may refer to only one aircraft and/or a specific maintenance task that cannot be scheduled into the maintenance opportunities as provided. For example, assuming the aircraft routes generated at step 104 have provided an 8 hour MO for a specific tail number (or aircraft) on a specific day t, so that the aircraft is scheduled to fly out at 7:00 am. However, a given maintenance task may require 10 consecutive hours to be executed. If the aggregated maintenance constraints consider total labor-hours for performing the due maintenance tasks, and not the labor-hours needed for a specific due maintenance task, the need for a block of 10 consecutive hours is not considered. Therefore, a cut may be added as an additional constraint, forcing the given flight to fly out only at 9:00 am that day, to increase the MO by 2 hours and allow the given maintenance task to be performed. Step 104 is repeated with the aggregated maintenance constraints and the additional cuts in order to generate newly proposed aircraft routes, and step 106 may be repeated to schedule the due maintenance tasks using the newly proposed aircraft routes. Loop A may be repeated until a feasible solution is obtained.

Using the method 100, the maintenance workload of each aircraft over the upcoming time period may be estimated and considered for AMR as a maintenance constraint. For example, if the time period is set to one week, week-long routes are generated while ensuring sufficient MO per individual aircraft that will assure the requested workload. In some embodiments, an objective may be to minimize the positioning flights' costs while minimizing deviating from the EFU. For MTS, the route of each individual aircraft may be considered in terms of various usage parameters and each due maintenance task is assigned to a feasible MO. A usage parameter is a pre-defined aging factor to express the interval of the maintenance tasks such as Flight Hour (FH), Flight Cycle (FC), Engine Hour (EH), Engine Cycle (EC), Auxiliary Power Unit Hour (APUH), and Time Calendar (TC). A feasible MO refers to an MO in which a task can be scheduled without violating a target due date. MTS may be performed in order to minimize the gap between the target due date and the actual timing of each task, and to balance the total maintenance workload over the week.

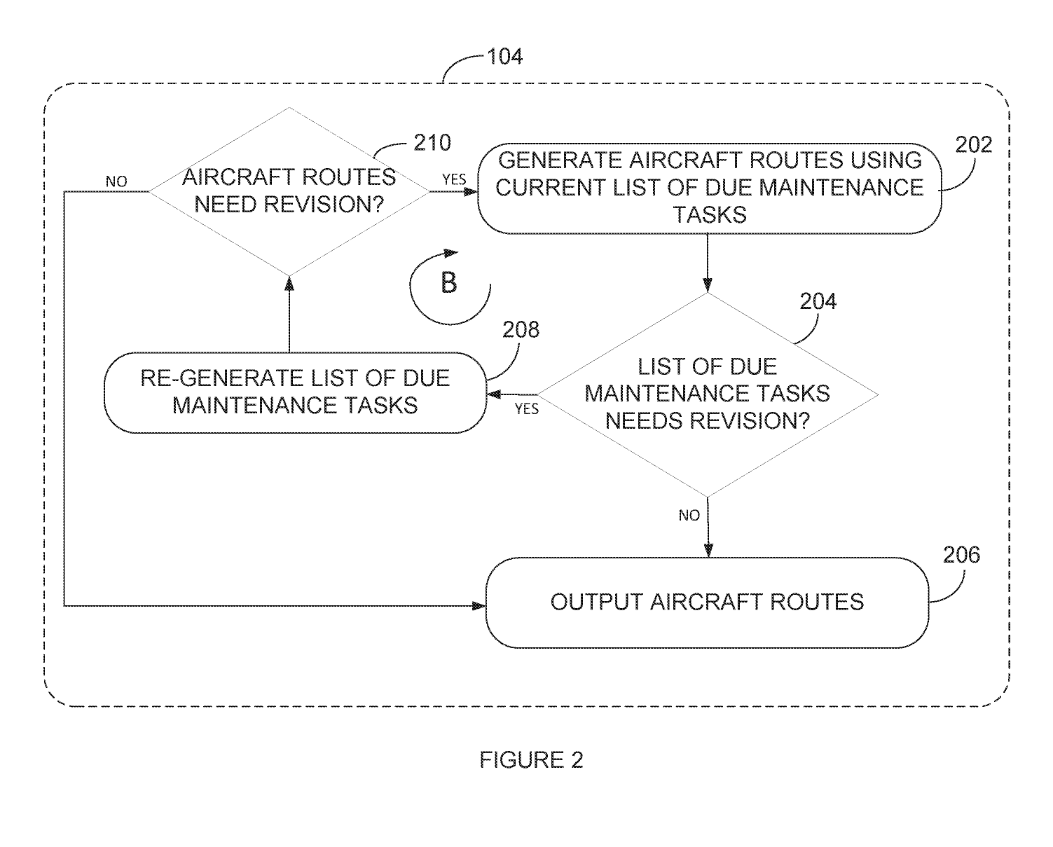

FIG. 2 is an exemplary embodiment for generating a set of aircraft routes, as per step 104. A first set of aircraft routes are generated using the initial list of due maintenance tasks, as per step 202. Step 204 comprises determining if the initial list of due maintenance tasks needs revision in view of the first set of aircraft routes (for example, does the first set of aircraft routes alter FH, FC or EC, requiring an adjustment in maintenance tasks needed). If so, an updated list of due maintenance tasks is generated based on the first set of aircraft routes, as per step 208. Step 210 comprises determining if the first set of aircraft routes needs revision in view of the updated list of due maintenance tasks. If so, step 202 of generating aircraft routes may be repeated with the updated list of due maintenance tasks. Loop B is repeated until either one of the due maintenance tasks or the aircraft routes no longer need revision. Once a stable solution has been reached, the set of aircraft routes are output, as per step 206. It is expected that loop B will converge to a stable list after a finite number of iterations. However, should it be locked into a finite set of similar lists because of the existence of degeneration, i.e. multiple optimal routings, similar lists may be merged together to create a final list of aircraft maintenance routes for MTS.

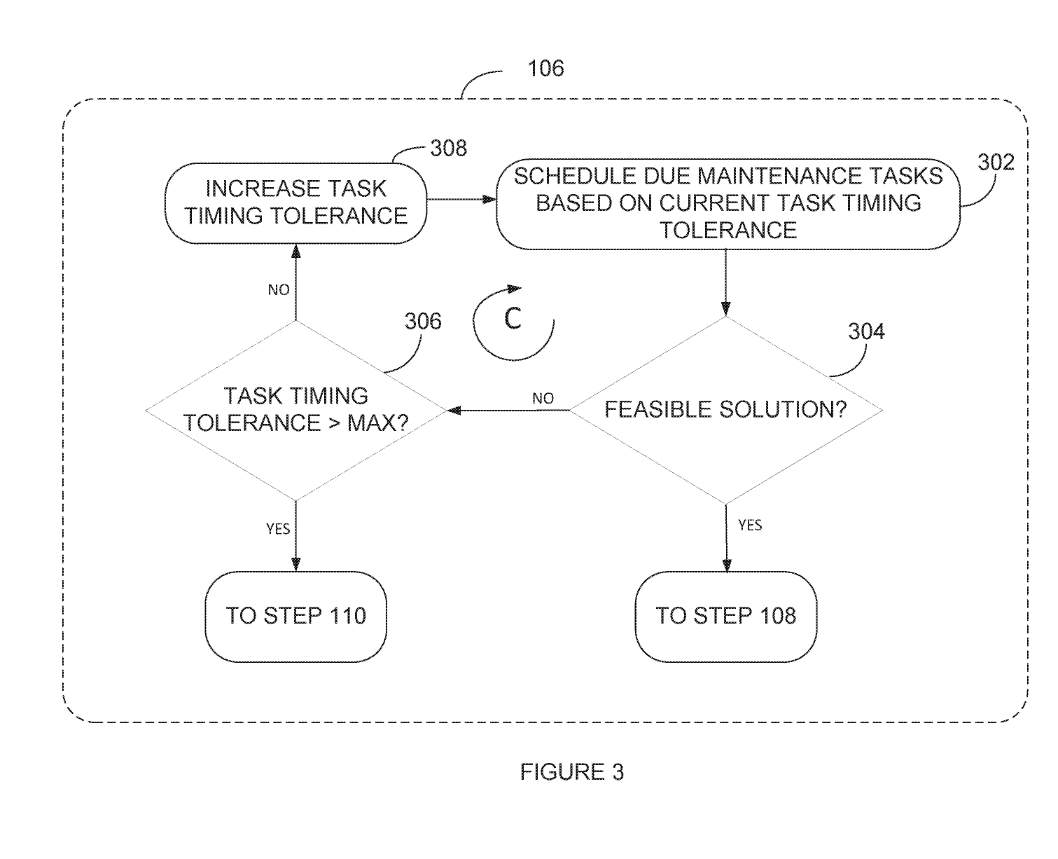

FIG. 3 is an exemplary embodiment for scheduling the due maintenance tasks into the maintenance opportunities, as per step 106. Scheduling may be first performed based on an initial task timing tolerance, as per step 302. Task timing tolerance refers to a maximum allowable gap by which the actual time at which a maintenance task is scheduled may exceed the target due date of the task. If the due maintenance tasks cannot be scheduled with the initial task timing tolerance, i.e. a solution is infeasible (step 304), the task timing tolerance may be increased, as per step 308. The scheduling of step 302 may be repeated based on the increased task timing tolerance. Note that task timing tolerance may only be increased until a maximum task timing tolerance has been reached (step 306), after which it is determined that there is no feasible solution for the current list of maintenance tasks to be scheduled in the current set of aircraft routes. Loop C is thus repeated until the maximum task timing tolerance has been reached or until a feasible solution is obtained, whichever occurs first.

Various models may be used to generate the set of aircraft routes of step 104. For example, network-based and string-based models may be used to formulate the AMR. Network-based models can be divided into three main groups: City-Day Networks (CDN), Time-Space Networks (TSN), and Connection Networks (CN). CDNs are flight-leg networks in which the nodes represent stations, and the arcs between the nodes represent flight legs, connecting these stations. TSNs are an extended version of CDNs; to keep track of the departure and arrival times of flight legs, each station is represented by a time-line consisting of a series of event nodes occurring sequentially. Each node represents an event of a flight departure or arrival at the station. TSNs are used to create the rotation tour, satisfying daily maintenance constraints. Depending on the problem structure and assumptions, different types of arcs may be used in TSNs, including ground, flight; overnight (wrap-around), and time-reversible arcs. In CNs, the nodes represent the flight legs, and the arcs represent the feasible connections among them. In string-based models, a string is simply defined as a sequence of connected flights that satisfies flow balance while being feasible to maintain. One approach to string-based models is Column Generation (CG).

When using CNs, it is possible to trace individual aircraft through the flight network with respect to different flight attributes or usage parameters. However, the number of arcs progressively increases with the size of the network, number of flight legs, and size of the fleet. Since the requirement of individual aircraft may be a consideration, a CN-based formulation is presented as a Mixed Integer Programming (MIP) model, and may be solved using a CG method developed based on the string-based model.

The MIP formulation may be a resource-constrained routing problem in the form of a connection network in which the nodes represent the flight legs, and the arcs represent the feasible connections between them. The arc between two legs i and j, i.e., (i, j), may be a feasible connection if enough time exist between arrival time of i and departure time of j to complete all ground operations, including aircraft preparation. The arc (i, j) may also be a maintenance—feasible connection if at least one origin station of i, or departure station of j is a maintenance station. The cost of arc (i, j), C_{(i, j)}, represents the operating costs related to the non-revenue (positioning) flight to differentiate the origin of j from the destination of i. Decision variable x^{a}(i,j) equals one if arc (i, j)εΛ is flown by aircraft aεΩ; otherwise, it equals zero. Set Λ represents the set of all feasible connections in the network and Ω is the set of all individual aircraft in the fleet; ζ is the set of all flight legs scheduled over the week, including dummy flight leg, Source to Sink. The proposed mathematical model for AMR may be written as:

$$\begin{matrix}P \text{:} \\ min Z = {\sum }_{a ∈ Ω} {\sum }_{( i , j ) ∈ Λ} {C}_{( i , j )}^{a} {x}_{( i , j )}^{a} + γ \times {\sum }_{a ∈ Ω} {\sum }_{t = 1}^{T} ( {e}_{at}^{+} + {e}_{at}^{-} ) , \\ + ρ \times {\sum }_{a ∈ Ω} {\sum }_{{t}_{1} = 1}^{T} {\sum }_{{t}_{2} = 1}^{T} ( {\sum }_{s = {t}_{1}}^{{t}_{2}} {\sum }_{( i , j ) ∈ Λ} {x}_{( i , j )}^{a} {p}_{( i , j )}^{as} - {\sum }_{m = 1}^{M} {λ}_{m , [ {t}_{1} , {t}_{2} ]}^{a} {D}_{m} ) , & ( 1 ) \\ s . t \text{:} & \\ {\sum }_{a ∈ Ω} {\sum }_{( i , j ) ∈ Λ} {x}_{( i , j )}^{a} = 1 ∀ i ∈ ς , & ( 2 ) \\ {\sum }_{j ∈ ς} , {x}_{( source , j )}^{a} = {\sum }_{i ∈ ς} , {x}_{( i , sink )}^{a} ∀ a ∈ Ω , & ( 3 ) \\ {\sum }_{( i , j ) ∈ Λ} {x}_{( i , j )}^{a} = {\sum }_{( j , k ) ∈ Λ} {x}_{( j , k )}^{a} ∀ a ∈ Ω , j ∈ ς , & ( 4 ) \\ {\sum }_{( i , j ) ∈ Λ ( \leq t )} {l}_{i} \times {x}_{( i , j )}^{a} + {e}_{at}^{+} - {e}_{at}^{-} = \frac{1}{\vert Ω \vert} {\sum }_{i ∈ ς ( \leq t )} {l}_{i} ∀ a ∈ Ω , t , \\ {x}_{( i , j )}^{a} ∈ \{ 0 , 1 \} , {e}_{at}^{+} , {e}_{at}^{-} \geq 0 & ( 5 )\end{matrix}$$

The first term in Eq. (1) represents the additive costs of routing, i.e., costs of connections. The second term is a cumulative cost used to equalize the cumulative usage of individual aircraft over the time horizon. The real variables eₐₜ⁺ and eₐₜ⁻ which represent the usage deviation, are determined in Eq. (5) as surplus and slack variables. The best case scenario, i.e., eₐₜ⁺=eₐₜ⁻=0∀a, t, is an EFU scenario in which all airplanes have the same cumulative usage rate over the nested intervals [1, t]; t=1, . . . , T. Coefficient γ represents the unit penalty of deviation from the EFU scenario. The condition (≦t) in Eq. (5) refers to the set of all feasible connections (i, j)εΛ up to day t. The left side of Eq. (5) calculates the average aircraft usage up to day tᵢ and lᵢ is the required flight hours for flight leg iεζ. The last term in Eq. (1) represents a penalty function associated with the maintenance constraints of individual aircraft. It minimizes maintenance infeasibility and misalignment between MOs embedded within the routes and projected due maintenance tasks. The quantity ρ represents the penalty coefficient as an arbitrary positive number so that ρ>max{C_{(i,j)}}. Eqs. (2), (3) and (4) represent the classical constraints of a routing problem to ensure all flight legs are covered and the flow continuity per aircraft holds. Finally, the route of each aircraft starts from Source and ends in Sink.

The maintenance constraints per aircraft may be defined in such a way that the planned routes provide sufficient MOs, or capacity, to satisfy the projected due maintenance tasks, or demand. The constructed constraints may take advantage of the flexibility existing in the allowable tolerance on task timing. The constraints may be built so that the planned routes ensure enough time overlaps between capacity and demand. To capture the allowable flexibility on timing of the tasks, the following rules may be used to determine the Allowable Timing Interval (ATI) of a maintenance task:

Predating maintenance is allowed so that the actual time of given task m can range between the allowable tolerance on early maintenance, δ⁻, and its target due date dₘ.
Postdating (overdue) maintenance is allowed if a late tolerance on dₘ, δ⁺ is allowed.

From a practical point of view, both δ⁻ and δ⁺ are determined as a percentage of the task interval, while δ⁺ should be smaller than δ⁻ since overdue maintenance is prohibited. As a common practice, local authorities usually designate δ⁻=0.1×dₘ and δ⁺=0, indicating overdue tasks are not allowed.

The generalized maintenance constraints may be built using a capacity planning-based strategy whereby the capacity provided over each sub-interval [t₁, t₂]⊂[1, T] s should satisfy the total demand belonging to set ψ_{[t}_{₁}_{,t}_{₂}_{]}^{a} where

ψ_{[t}_{₁}_{,t}_{₂}_{]}^{a}={m|[dₘ^{a}−δ⁻,dₘ^{a}+δ^{+]⊂[}t₁,t₂]};∀1≦t₁≦t₂≦T. (6)

ψ_{[t}_{₁}_{,t}_{₂}_{]}^{a} is the set of all tasks whose allowable timing interval is a subset of [t₁, t₂].

The following constraints should hold for each sub-interval [t₁, t₂] and aircraft aεΩ:

Σₛ₌ₜ_{₁}^{t}^{₂}Σ_{(i,j)εΛ}x_{(i,j)}^{a}p_{(i,j)}≧Σₘ₌₁^{M}λ_{m,[t}_{₁}_{,t}_{₂}_{]}^{a}Dₘ∀aεΩ;1≦t₁≦t₂≦T, (7)

where T is the length of the planning horizon (in days) and p_{(i,j)}^{as} is the MO (in hours) provided by arc (i, j)εΛ on day t. The left-hand side of (7) is the capacity provided by the route of aircraft a on day t, and Dₘ is the required man-hours for task m. The right-hand side of (7) represents the due maintenance tasks of aircraft a projected using the last routing, and M is the number of tasks in the maintenance program. The quantity π_{m,[t}_{₁}_{,t}_{₂}_{]}^{a}=1, if mεψ_{[t}_{₁}_{,t}_{₂}_{]}^{a}; otherwise, it is zero.

To solve AMR using the developed CG method, the Master Problem (MP) may be designed such that the most promising columns generated by a slave problem, called the pricing problem, are selected (in the present case, each column represents a route for the given time period). In general, the MP may be a relaxed Linear Programming (LP) set-partitioning problem in which each set element (flight leg) belongs to certain subsets (routes) with different degrees. The pricing problem may be a pure shortest path problem responsible for generating the columns to be passed to the MP. The dual information resulting from the MP is fed back to the pricing problem to determine the route with the minimum reduced cost. A permanent labeling algorithm may be used to solve the pricing problem. The interaction between the master and pricing problems will be terminated when we can no longer find a route with a reduced cost. Since the solution obtained from the MP is not necessarily an integer, we employ the branch-and-bound or branch-and-price method to obtain an integer solution, i.e., a solution in which each flight leg appears in one route.

In order to consider the maintenance requirements of individual aircraft, each column (generic route) generated by the pricing problem may be a maintenance-feasible route for at least one aircraft in the fleet. Each column can be a route for an individual aircraft with a certain degree of maintenance feasibility. The idea is to generate a pool of Generic Feasible Routings (GFR), each of which can be converted to different Maintenance-Feasible Routings (MFR) with various maintenance infeasibility degrees. A GFR refers to a set of generic routes covering all flight legs so that each one appears in exactly one route. An MFR refers to a map/assignment from a given GFR to the individual aircraft, leading to a certain degree of maintenance infeasibility. One possible solution is the MFR with least maintenance infeasibility. To implement this, we first consider the following as a master problem:

MP:min Σᵣ₌₁^{L}Cᵣyᵣ, s.t: Σᵣ₌₁^{L}aᵢᵣyᵣ=1∀iεζ,yᵣε{0,1},|

where L is the size of the column archive updated by the pricing problem. The binary decision variable yᵣ=1, if column (generic route) r is selected; otherwise, it is zero. The reduced cost cᵣ represents the average maintenance infeasibility of column r so that cᵣ=(1/|Ω|)×Σ_{aεΩ}cᵣₐ, and cᵣₐ is the degree of maintenance infeasibility of column r for aircraft a. After the pricing problem is terminated, the archive is updated and the MP is solved using the simplex method to obtain the dual values associated with each flight leg i, πᵢ. If there is a significant change in the dual values, the reduced costs of each existing column r are updated as c̅ᵣ̅=cᵣ−Σ_{iεζ}aᵢᵣπᵢᵣ and the pricing problem is re-applied. By relaxing the flight coverage constraint (2) and using the Dantzig-Wolf decomposition strategy, model P is decomposed into the number of |Ω| Resource Constrained Shortest Path (RCSP) problems where each corresponds to an individual aircraft. The objective is to minimize the objective function (1) and to satisfy constraints (5) and (7) as much as possible. These RCSP problems represent the pricing problems. The models try to generate a maintenance-feasible route per individual aircraft but offer no guarantee for covering all flight legs; however, the EFU goal encourages the model to cover as many flight legs as possible. The RCSP problems are solved using a dynamic programming approach (DPA). Using this decomposition, more than one column is generated per iteration, thus accelerating the solving process. When the MP is terminated, a branching algorithm may be employed to search the column archive for all possible GFRs. The Hungarian algorithm may be used to turn the GFR into an MFR with least maintenance infeasibility. This may be equivalent to solving a route-to-aircraft assignment problem per GFR.

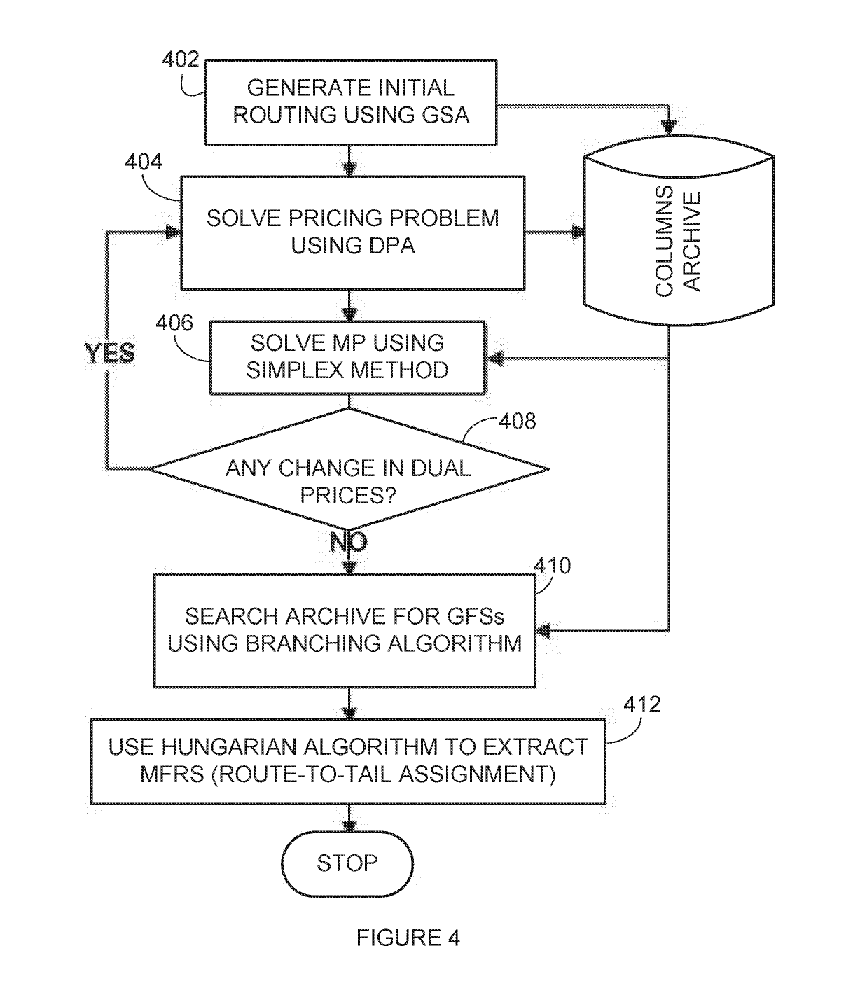

The structure of the developed CG method is shown in FIG. 4. As per step 402, a Greedy Search Algorithm (GSA) may be used to generate an initial GFR. It employs a vertical routing strategy with a forward procedure ensuring all flight legs will be covered. All flight legs are ranked in ascending order of their departure times, regardless of the departure station. The overall procedure may be designed to assign the flight legs to an available aircraft based on the greedy strategy. The algorithm may be terminated when the Sink node is reached, as all flight legs have been assigned. To ensure feasibility, it is assumed that positioning (non-revenue) flights are allowed with a high cost. However, a restart subroutine with penalization policy is embedded within the algorithm to reduce the number of possible non-revenue flights. The general steps of the GSA are as follows:

| | |
|---|---|
| 1. | Rank the flight legs in ascending order of departure time, irrespective of their |
| | departure station. |
| 2. | Set e(a) = Source; ∀a∈Ω, where e(a) is the last flight leg covered by aircraft a thus far. |
| 3. | Set A(l) = Ø; ∀l∈ [symbol] , where A(l) stores the aircraft index assigned to leg l. |
| 4. | Set p_{(i,j)} = 0 ∀(i,j) ∈ Λ, where p_{(i,j)} is the penalty associated with arc (i,j). |
| 5. | l = 1; l represents the index of ranked flight legs. |
| 6. | a* = arg min_{a∈Ω}{C_{(e(a),l)} + p_{(e(a),l)}\|(e(a),l) ∈ Λ} |
| 7. | If (e(a*),l) requires a ferry flight, create set Δₗ = {i\|(i,l) ∈ Λ and p_{(i,A(i))} = 0}. |
| | If Δₗ ≠ Ø, let p_{(i,A(i))} = M⁺, where j is the last element of Δₗ , and go to Step 2. |
| | Otherwise, go to Step 8. |
| 8. | Set e(a*) = l and A(l) = a*. |
| 9. | If i < \| [symbol] \|, set l = l + 1 and go to Step 4 Else Stop. |

Since a positioning flight is allowed, a null a* in Step 6 will never happen; therefore, the GFR solution may be assured. The set Δₗ represents all possible predecessors of leg l in the connection network which have not yet been penalized. When Δₗ is not empty, we penalize the current assignment related to the last element of set Δₗ and the algorithm is restarted. This penalization provides an assignment opportunity with no positioning flight for leg l during the restart procedure. If Δₗ is empty, the positioning flight must be accepted.

To solve RCSP problems for pricing purposes and update the column archive, a DPA with a horizontal routing strategy may be used, as per step 404, and a forward procedure in which a week-long route is created per aircraft at each iteration. However, the full coverage of all legs cannot be guaranteed. Consequently, some artificial columns may be added to the MP to cover the unassigned flight legs, as per step 406. At each iteration of DPA, a version of the label pulling algorithm is used to solve each RCSP problem. The developed DPA allows the tracing of the consumption of two types of labels, ‘aircraft utilization’ and ‘maintenance opportunity’, corresponding to constraints (5) and (7) respectively. Since both constraints are assumed to be soft cumulative constraints, a penalty coefficient is considered for the violation of each one. We consider a dominance policy in which the partial routes violating constraint (7) to a smaller degree strongly dominate the routes violating constraint (7) to a higher degree, no matter how much constraint (5) is violated. The algorithm works by pulling labels from all possible predecessor legs to a given leg, while updating cumulative costs (including penalties) and resource consumption. While the EFU goal encourages the DPA to cover all flight legs, a GFR solution is not always guaranteed due to the high penalty of maintenance infeasibility. The aircraft may be initially prioritized in terms of their due maintenance tasks so that those with a greater workload have a higher routing priority.

The proposed DPA has a positive impact on the convergence speed of CG. Generally, the CG has a tendency to converge slowly due to a pure column generation algorithm, and it takes a long time to obtain a feasible solution. The proposed DPA adds more than one column to the archive per iteration; in the best case scenario, this is |Ω| columns. When this is added to the relatively high diversity of the columns in the archive due to the dual information updating and penalization strategies applied in the main recursive function of the proposed DPA, an extensive exploration of the feasible space in a reasonable amount of time is possible.

When no additional change in the dual values is possible (step 408), we need to search the archive for all possible GFRs. For this purpose, a branching algorithm with a binary search tree and depth-first-then-breath strategy may be used, as per step 410. The search tree consists of L levels and 2^{L} nodes at each level where L=archive size. Each level corresponds to a column in the archive. At each level, the branching strategy decides whether the corresponding column must be selected or not. At level l, a GFR is obtained, if the columns selected satisfy three conditions. First, they may be independent (no pairs of columns have a flight leg in common). Second, all flight legs may be covered. Third, the fleet size should not be exceeded. Whenever a GFR is found, it is added to the GFR pool. Let S^{l} be the set of selected columns up to level l and ψ(S^{l}) be the set of all flight legs covered by S^{l}. R^{l} is the set of unselected columns corresponding to levels l+1 to L. To perform depth branching, the next feasible column r c R′ is chosen in such a way that S^{l}∪r is still a disjoint set, i.e., a set with mutually independent elements, or equivalently ψ(S^{l})Ωψ({r}=ø. If such a column r does not exist or |S^{l}|=|Ω|, the corresponding sub-tree is infeasible and the current node should be fathomed; otherwise, the depth branching is continued. At each level, the index of the next feasible column is stored in the memory to trace the way back during the backtracking phase.

The final step of the CG method is to extract the possible MFRs from the pool of GFRs, as per step 412. To do so, a Route-to-Aircraft Assignment Problem (RAAP) is solved per GFR; that is, a maintenance-feasible route (from the given GFR) is assigned to each individual aircraft. The sole objective of the RAAP is to minimize maintenance infeasibility, assuming that each column in the archive is a route for each individual aircraft with a certain degree of maintenance feasibility. The Hungarian Method may be used to solve the RAAP as a classical balanced assignment problem. The term ‘balanced’ supports the assumption that the cost matrix is square. That is, the size of all GFRs equals the fleet size (|Ω|); otherwise, some artificial columns with a high penalty are added to the cost matrix to cover the unused aircraft. The steps of Hungarian method are as follows:

1. For each row of cost matrix, find minimum entry and subtract it from each entry in the row. Likewise, for each column of cost matrix, find minimum entry and subtract it from each entry in the column.
2. Cross out the minimum number of rows and columns in the cost matrix to cover all 0 entries.

a. If |Ω| lines are used in Step 2 to cover, Stop.

b. If fewer than |Ω| lines are used in Step 2 to cover, go to Step 3.

3. Find the minimal entry not crossed out in Step 2. Add this entry to all elements that are doubly crossed out in Step 2 and subtract from all entries of the cost matrix that are not crossed out.

### 4. Return to Step 2.

The main difficulty with the Hungarian method for large matrices is in Step 2: how to determine the minimum number of rows and columns to cover all zero entries. For relatively small assignment problems, this can be done by inspection, but for large matrices, the number of feasible combinations of the covered zeros grows progressively. According to König's Theorem, in bipartite graphs, the minimum number of lines (rows or columns) which contain all the zero entries of a matrix is equal to the maximum number of independent zero entries. A set of matrix entries is independent if no two entries are in the same row or column. Based on the above theorem, the König algorithm is used in Step 2 to produce both the smallest cover and the largest independent set of zeros.

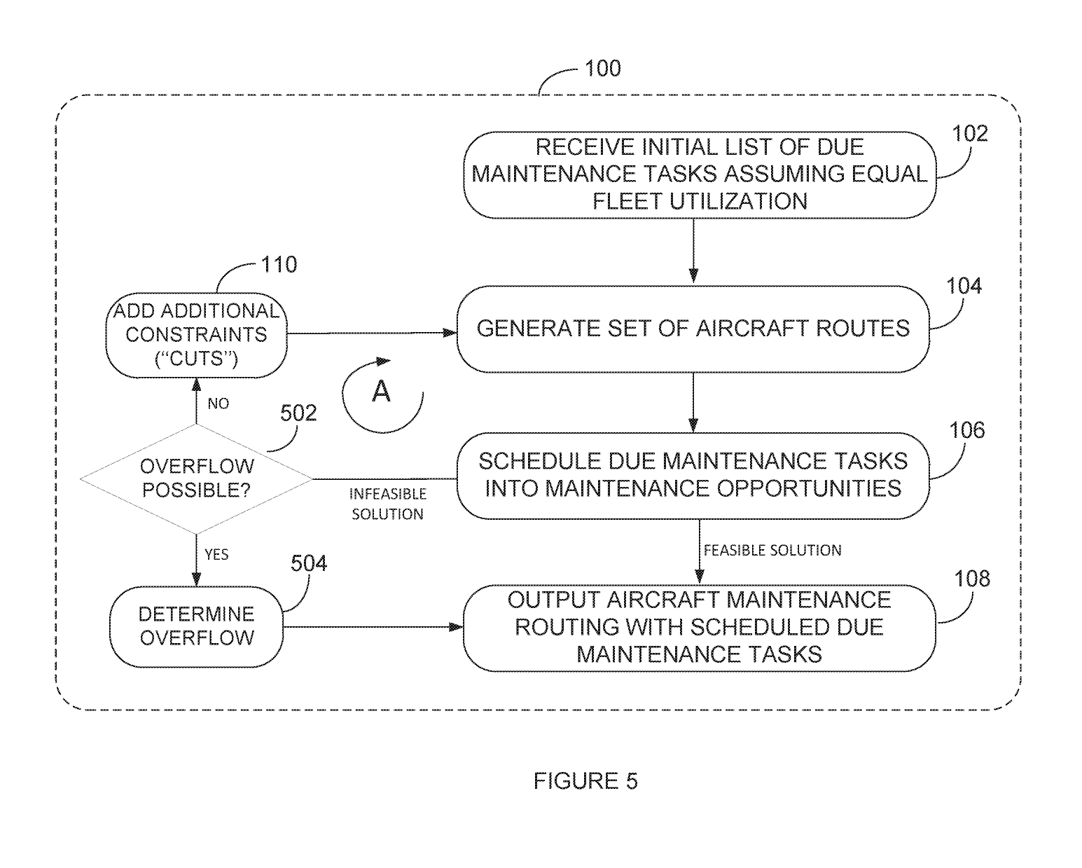

In some embodiments, the method 100 may comprise one or more steps related to investigating whether due maintenance tasks that cannot be scheduled can be treated as overflow. Overflow refers to moving tasks back to previous periods and treating them prematurely. An exemplary embodiment is illustrated in FIG. 5. In this example, in the case of an infeasible solution resulting from step 106, an overflow determination is made in step 502. If task(s) cannot be moved forward to previous periods, the method 100 continues to step 110 of adding additional cuts to repeat loop A. If the task(s) may indeed be moved forward and treated as overflow, then an overflow determination step 504 is performed and the aircraft maintenance routing with scheduled due maintenance tasks is output accordingly.

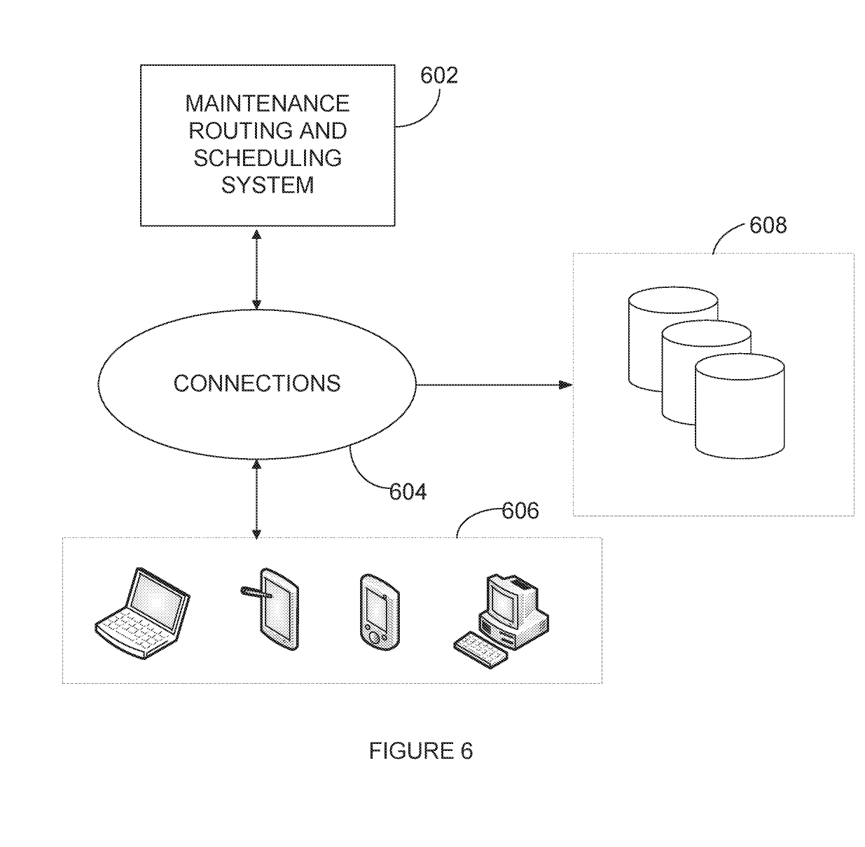

Referring to FIGS. 6 to 10, the system for coordinating maintenance routing and scheduling will now be described. In FIG. 6, there is illustrated a maintenance routing and scheduling system 602. The maintenance routing and scheduling system 602 may be accessible remotely from any one of a plurality of devices 606 over connections 604. The devices 606 may comprise any device, such as a personal computer, a tablet, a smart phone, or the like, which is configured to communicate over the connections 604. In some embodiments, the maintenance routing and scheduling system 602 may itself be provided directly on one of the devices 606, either as a downloaded software application, a firmware application, or a combination thereof.

Various types of connections 604 may be provided to allow the maintenance routing and scheduling system 602 to be accessed remotely. For example, the connections 604 may comprise wire-based technology, such as electrical wires or cables, and/or optical fibers. The connections 604 may also be wireless, such as RF, infrared, Wi-Fi, Bluetooth, and others. Connections 604 may therefore comprise a network, such as the Internet, the Public Switch Telephone Network (PSTN), a cellular network, or others known to those skilled in the art. Communication over the network may occur using any known communication protocols that enable devices within a computer network to exchange information. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

One or more databases 608 may be integrated directly into the maintenance routing and scheduling system 602 or any one of the devices 606, or may be provided separately therefrom (as illustrated). In the case of a remote access to the databases 608, access may occur via connections 604 taking the form of any type of network, as indicated above. The various databases 608 described herein may be provided as collections of data or information organized for rapid search and retrieval by a computer. The databases 608 may be structured to facilitate storage, retrieval, modification, and deletion of data in conjunction with various data-processing operations. The databases 608 may be any organization of data on a data storage medium, such as one or more servers. The databases 608 illustratively have stored therein one or more of historical fleet information, maintenance programs, due maintenance tasks, updated maintenance tasks, aircraft routes (with or without maintenance tasks scheduled therein), maintenance constraints, task timing tolerances, and algorithms and/or parameters therefor such as column generation, branch and bound, greedy search, MIP formulations, dynamic programming approach, branching algorithm, and Hungarian method.

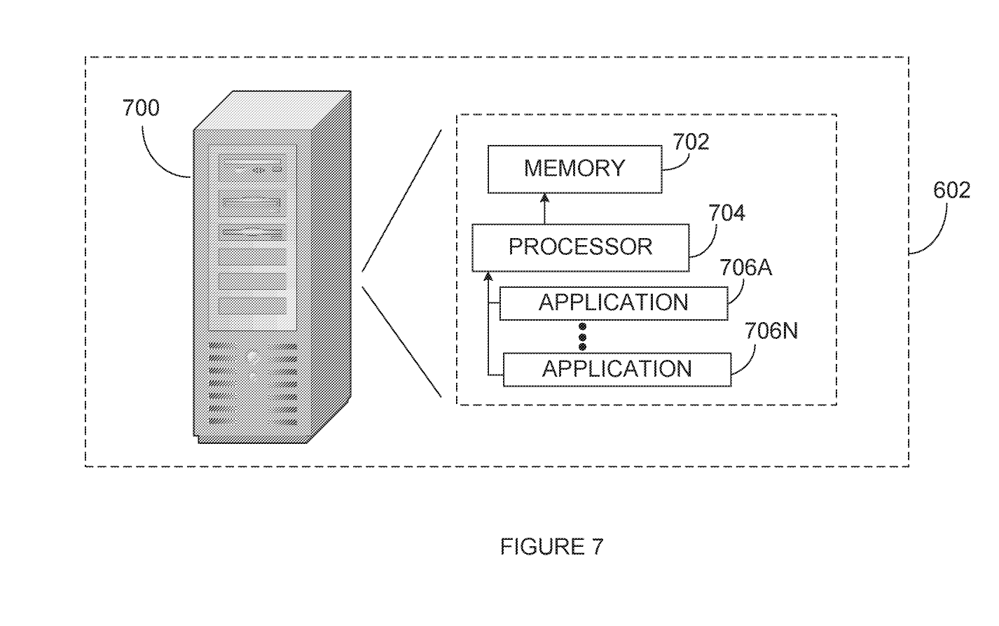

As shown in FIG. 7, the maintenance routing and scheduling system 602 illustratively comprises one or more server(s) 700. For example, a series of servers corresponding to a web server, an application server, and a database server may be used. These servers are all represented by server 700 in FIG. 7. The server 700 may be accessed by a user using one of the devices 606, or directly on the system 602 via a graphical user interface. The server 700 may comprise, amongst other things, a plurality of applications 706a . . . 706n running on a processor 704 coupled to a memory 702. It should be understood that while the applications 706a . . . 706n presented herein are illustrated and described as separate entities, they may be combined or separated in a variety of ways.

The memory 702 accessible by the processor 704 may receive and store data. The memory 702 may be a main memory, such as a high speed Random Access Memory (RAM), or an auxiliary storage unit, such as a hard disk, a floppy disk, or a magnetic tape drive. The memory 702 may be any other type of memory, such as a Read-Only Memory (ROM), or optical storage media such as a videodisc and a compact disc. The processor 704 may access the memory 702 to retrieve data. The processor 1104 may be any device that can perform operations on data. Examples are a central processing unit (CPU), a front-end processor, a microprocessor, and a network processor. The applications 706a . . . 706n are coupled to the processor 704 and configured to perform various tasks. An output may be transmitted to the devices 606.

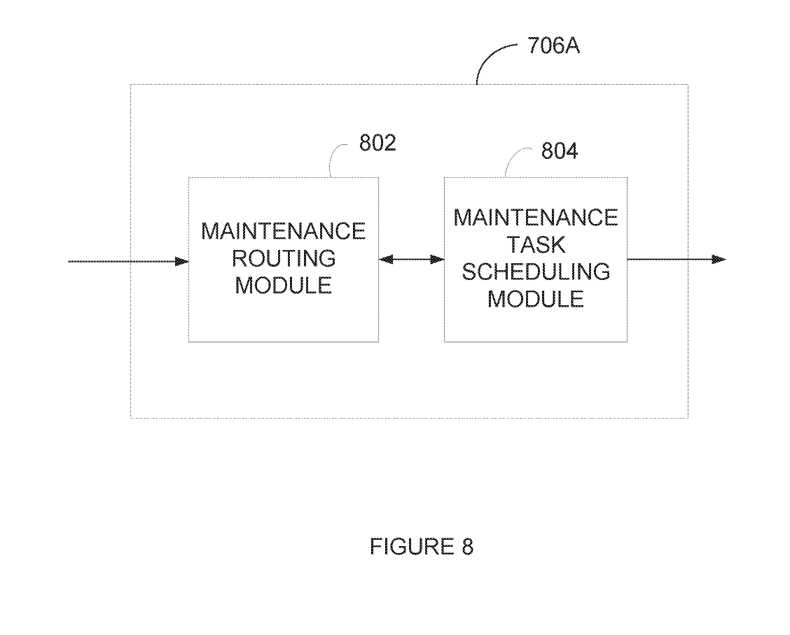

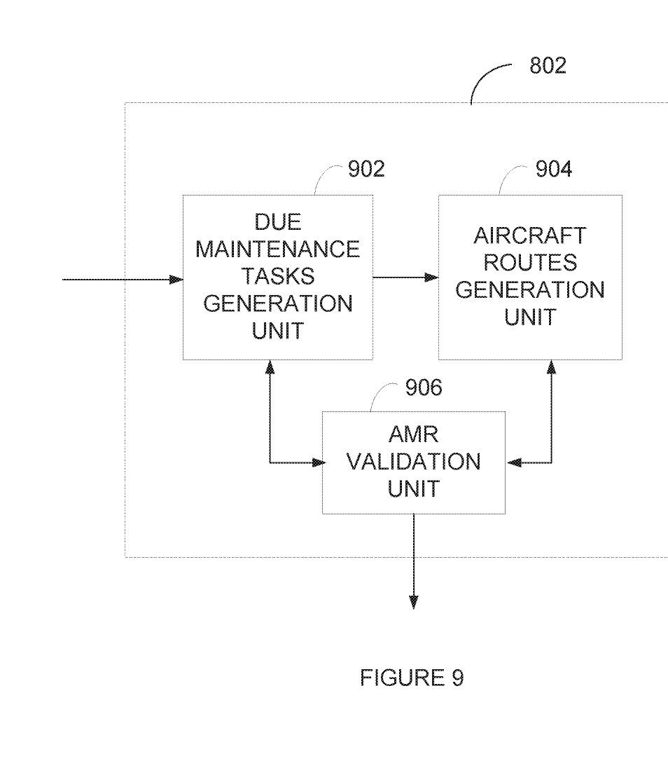

FIG. 8 is an exemplary embodiment of an application 706a running on the processor 704. The application 706a illustratively comprises a maintenance routing module 802 and a maintenance task scheduling module 804. The maintenance routing module 802 is illustratively presented in FIG. 9 as comprising a due maintenance tasks generation unit 902, an aircraft routes generation unit 904, and an AMR validation unit 906. The due maintenance tasks generation unit 902 may be configured to generate the initial list of due maintenance tasks and update this list as required. The aircraft routes generation unit 904 may be configured to receive as input the initial list of due maintenance tasks and generate the set of aircraft routes. In some embodiments, the initial list of due maintenance tasks is generated remotely from the maintenance routing module 802 and received directly by the aircraft routes generation unit 904. The AMR validation unit 906 may be configured to determine whether either one of the list of due maintenance tasks and the aircraft routes need revision, as per steps 204 and 210 of FIG. 2. In case of a needed revision, either one of the due maintenance tasks generation unit 902 and the aircraft routes generation unit 904 is instructed to regenerate its output accordingly. Outputs are transmitted to the AMR validation unit 906 until it has been determined that no further revision is necessary and the output may be provided to the maintenance tasks scheduling module 804.

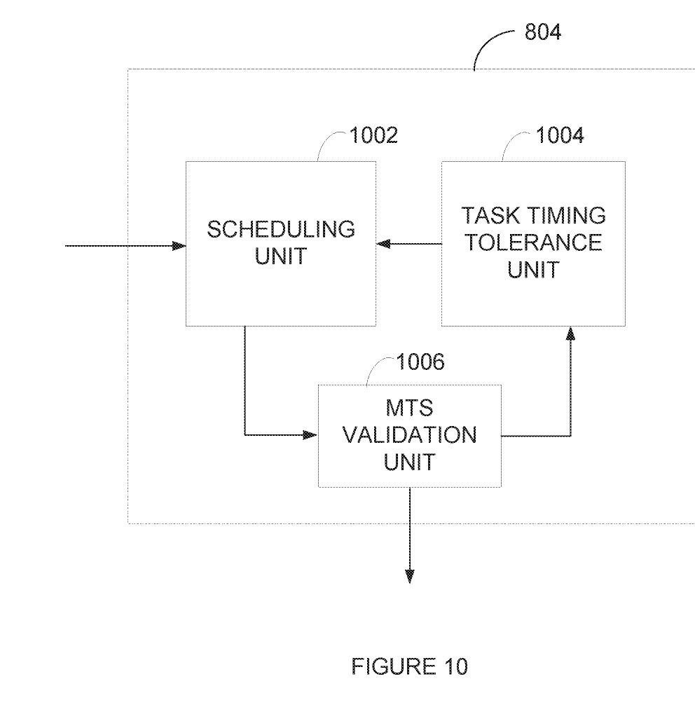

FIG. 10 is an exemplary embodiment of the maintenance tasks scheduling module 804, There is provided a scheduling unit 1002, a task timing tolerance unit 1004, and an MTS validation unit. In some embodiments, an overflow unit may also be provided, as per steps 502, 504 of FIG. 5. The scheduling unit 1002 may be configured to schedule the due maintenance tasks based on a current task timing tolerance, as per step 302 of FIG. 3. The outcome of the scheduling unit 1002 may be provided to the MTS validation unit 1006, for determination of whether the solution is a feasible or an infeasible one, as per step 304, and for determination of whether the task timing tolerance is greater than a maximum task timing tolerance, as per step 306. Depending on the outcome of these determinations, the MTS validation unit 1006 may signal the task timing tolerance unit to increase the task timing tolerance. The MTS validation unit 1006 may cause the maintenance task scheduling module 804 to loop back to the maintenance routing module 802 in case of an infeasible solution, or output the aircraft maintenance routing with scheduled due maintenance tasks in case of a feasible solution. Other variants to the configurations of the maintenance routing module 802 and the maintenance task scheduling module 804 may also be provided and the example illustrated is simply for illustrative purposes.

The above description is meant to be exemplary only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. For instance, the blocks may be performed in a differing order, or blocks may be added, deleted, or modified. While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment. The present disclosure may be embodied in other specific forms without departing from the subject matter of the claims. Also, one skilled in the relevant arts will appreciate that while the systems, methods and computer readable mediums disclosed and shown herein may comprise a specific number of elements/components, the systems, methods and computer readable mediums may be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims.

1. A method for coordinating aircraft maintenance routing and scheduling for a fleet of aircraft over a given time period, the method comprising:
receiving an initial list of due maintenance tasks based on aircraft information of the fleet and a proposed fleet utilization distribution;
generating a set of aircraft routes for the fleet, the routes comprising maintenance opportunities for the due maintenance tasks, the due maintenance tasks being considered as aggregated maintenance constraints for generation of the aircraft routes;
scheduling the due maintenance tasks into the maintenance opportunities while respecting target due dates; and
in case of infeasibility for maintenance task scheduling within the maintenance opportunities of the aircraft routes, regenerating the set of aircraft routes for the fleet using the aggregated maintenance constraints and additional constraints, and rescheduling the due maintenance tasks using the regenerated set of aircraft routes.

2. The method of claim 1, wherein generating a set of aircraft routes comprises:
generating a first set of aircraft routes based on the initial list of due maintenance tasks;
determining if the initial list of due maintenance tasks needs revision in view of the first set of aircraft routes and if so generating an updated list of due maintenance tasks; and
determining if the first set of aircraft routes need revision in view of the updated list of due maintenance tasks and if so generating an updated set of aircraft routes.

3. The method of claim 1, wherein scheduling the due maintenance tasks into the maintenance opportunities comprises:
scheduling the due maintenance tasks based on an initial task timing tolerance;
if the due maintenance tasks cannot be scheduled with the initial task timing tolerance, increasing the task timing tolerance and repeating the scheduling based on the increased task timing tolerance; and
determining infeasibility for maintenance task scheduling when a maximum task timing tolerance is reached.

4. The method of claim 1, wherein the aggregated maintenance constraints correspond to labor-hours for a maintenance workload of each aircraft of the fleet over the given time period.

5. The method of claim 1, to wherein scheduling the due maintenance tasks into the maintenance opportunities comprises determining if tasks that cannot be scheduled may be moved forward to previous periods as overflow.

6. The method of claim 1, wherein scheduling the due maintenance tasks into the maintenance opportunities comprises consolidating similar tasks into work packages and assigning the work packages to the maintenance opportunities.

7. The method of claim 1, wherein generating a set of aircraft routes for the fleet comprises imposing a condition of at least one of reducing an uneven fleet utilization and reducing non-revenue flights.

8. The method of claim 1, wherein generating a set of aircraft routes for the fleet comprises using a column generation algorithm, wherein each column corresponds to a route for an individual aircraft with a degree of maintenance feasibility.

9. The method of claim 1, wherein scheduling the due maintenance tasks into the maintenance opportunities comprises using a branch-and-bound algorithm.

10. The method of claim 1, wherein the proposed fleet utilization distribution is an equal fleet utilization distribution.

11. The method of claim 1, wherein the additional constraints are specific to a given maintenance task that cannot be scheduled in the maintenance opportunities as provided.

12. A system for coordinating aircraft maintenance routing and scheduling for a fleet of aircraft over a given time period, the system comprising:
a memory;
a processor coupled to the memory; and
at least one application stored in the memory and executable by the processor for:
receiving an initial list of due maintenance tasks based on aircraft information of the fleet and a proposed fleet utilization distribution;
generating a set of aircraft routes for the fleet, the routes comprising maintenance opportunities for the due maintenance tasks, the due maintenance tasks being considered as aggregated maintenance constraints for generation of the aircraft routes;
scheduling the due maintenance tasks into the maintenance opportunities while respecting target due dates; and
in case of infeasibility for maintenance task scheduling within the maintenance opportunities of the aircraft routes, regenerating the set of aircraft routes for the fleet using the aggregated maintenance constraints and additional constraints, and rescheduling the due maintenance tasks using the regenerated set of aircraft routes.

13. The system of claim 12, wherein generating a set of aircraft routes comprises:
generating a first set of aircraft routes based on the initial list of due maintenance tasks;
determining if the initial list of due maintenance tasks needs revision in view of the first set of aircraft routes and if so generating an updated list of due maintenance tasks; and
determining if the first set of aircraft routes need revision in view of the updated list of due maintenance tasks and if so generating an updated set of aircraft routes.

14. The system of claim 12, wherein scheduling the due maintenance tasks into the maintenance opportunities comprises:
scheduling the due maintenance tasks based on an initial task timing tolerance;
if the due maintenance tasks cannot be scheduled with the initial task timing tolerance, increasing the task timing tolerance and repeating the scheduling based on the increased task timing tolerance; and
determining infeasibility for maintenance task scheduling when a maximum task timing tolerance is reached.

15. The system of claim 12, wherein the aggregated maintenance constraints correspond to labor-hours for a maintenance workload of each aircraft of the fleet over the given time period.

16. The system of claim 12, wherein scheduling the due maintenance tasks into the maintenance opportunities comprises determining if tasks that cannot be scheduled may be moved forward to previous periods as overflow.

17. The system of claim 12, wherein scheduling the due maintenance tasks into the maintenance opportunities comprises consolidating similar tasks into work packages and assigning the work packages to the maintenance opportunities.

18. The system of claim 12, wherein generating a set of aircraft routes for the fleet comprises imposing a condition of at least one of reducing an uneven fleet utilization and reducing non-revenue flights.

19. The system of claim 12, wherein generating a set of aircraft routes for the fleet comprises using a column generation algorithm, wherein each column corresponds to a route for an individual aircraft with a degree of maintenance feasibility.

20. The system of claim 12, wherein scheduling the due maintenance tasks into the maintenance opportunities comprises using a branch-and-bound algorithm.

21. The system of claim 12, wherein the proposed fleet utilization distribution is an equal fleet utilization distribution.

22. The system of claim 12, wherein the additional constraints are specific to a given maintenance task that cannot be scheduled in the maintenance opportunities as provided.

23. A computer readable medium having stored thereon program code executable by a processor for coordinating aircraft maintenance routing and scheduling for a fleet of aircraft over a given time period, the program code comprising instructions for:
receiving an initial list of due maintenance tasks based on aircraft information of the fleet and a proposed fleet utilization distribution;
generating a set of aircraft routes for the fleet, the routes comprising maintenance opportunities for the due maintenance tasks, the due maintenance tasks being considered as aggregated maintenance constraints for generation of the aircraft routes;
scheduling the due maintenance tasks into the maintenance opportunities while respecting target due dates; and
in case of infeasibility for maintenance task scheduling within the maintenance opportunities of the aircraft routes, regenerating the set of aircraft routes for the fleet using the aggregated maintenance constraints and additional constraints, and rescheduling the due maintenance tasks using the regenerated set of aircraft routes.

24. The computer readable medium of claim 23, wherein generating a set of aircraft routes comprises:
generating a first set of aircraft routes based on the initial list of due maintenance tasks;
determining if the initial list of due maintenance tasks needs revision in view of the first set of aircraft routes and if so generating an updated list of due maintenance tasks; and
determining if the first set of aircraft routes need revision in view of the updated list of due maintenance tasks and if so generating an updated set of aircraft routes.
